(19) United States
(12) Patent Application Publication
(10) Pub. No.: US 2024/0392106 A1
(43) Pub. Date: Nov. 28, 2024

(54) IMPACT PROPERTIES OF EXPANDABLE POLYLACTIC ACID MOLDED FOAM ARTICLES

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/672,642

(22) Filed: May 23, 2024

Related U.S. Application Data
(60) Provisional application No. 63/503,858, filed on May 23, 2023.

(51) Int. Cl. C08K 3/34; C08K 3/04; C08K 3/22

(52) U.S. Cl. CPC C08K 3/346; C08K 3/04; C08K 3/22; C08K 2003/2265

(57) ABSTRACT

Protective packaging is provided herein including at least one molded foam article formed from polylactic acid and including ridges. These ridges advantageously improve the impact reduction and G-force protection properties of the molded foam article without substantially increasing the weight, resulting in a protective packaging having superior impact protection and lower weight than comparable expandable polystyrene-based packages.

### CROSS-REFERENCE TO RELATED APPLICATIONS

This application claims priority to U.S. Provisional Patent Application No. 63/503,858, filed May 23, 2023, which is incorporated herein by reference.

### FIELD OF THE DISCLOSURE

This disclosure relates generally to protective packaging and, in particular, relates to protective packaging formed from polylactic acid and including ridges.

### BACKGROUND

Molded foam articles are used in a variety of diverse industries including thermal insulation and protective packaging, construction, infrastructure support, foodservice, and consumer products such as surfboards. Molded foam articles are commonly produced from expandable polystyrene (EPS), which has a well-known manufacturing process. However, EPS-based foam articles suffer from a variety of drawbacks that require compensating the properties of the EPS-based foam articles so that they may successfully be used for their desired purpose.

Consumer-facing foam articles such as insulated shippers are commonly used for shipping meal kits, confectionary products, cakes, other perishable goods, and pharmaceutical items such as vaccines. The overall retail market in the United States was around $4.3 trillion in 2021, with ecommerce accounting for around $1 trillion. In 2022, sales from Amazon alone exceeded in-store sales from Wal-Mart, with over 11.5% of Wal-Mart's own sales occurring online. The vast majority of product packaging used to pack and ship fragile or perishable products purchased online are EPS-based insulated shippers typically enclosed in a corrugated cardboard box because direct application of tapes and other adhesives on the EPS-based shipper lose efficacy after a short period of time. Alternatively, some insulated EPS shippers are held together with straps or a shrink sleeve. However, both of these methods involve using a different material to keep the shipper lid secured to the base.

Alternatives to EPS-based shippers have taken the form of molded pulp packaging which, although recyclable on their own, still require additional components such as an outer corrugate layer, tape, or labels. Another alternative is thermoformed polyethylene terephthalate (PET), which again requires an additional component such as corrugate if used to ship impact-sensitive commodities. Another alternative uses inflatable air protectors using polyethylene film, but these inflatable protectors must be enclosed in corrugate to protect the integrity of the inflated protectors. Yet another alternative shipper takes the form of a wooden crate with packaging such as straw or paper strips, most commonly seen for shipping wine bottles. One attempt to homogenize the materials in a shipper takes the form of a corrugate-only shipper, but this solution sacrifices the thermal and impact protection characteristic of expandable foam packaging. Recycling each of these shippers requires additional effort and cost associated with separating the disparate components.

Previous attempts to mitigate the additional costs and drawbacks associated with material mismatch involve corrugated cardboard with paper-based tape and labels. However, the cost associated with tape, glue, varnish, and heavy printing on the corrugate result in increased levels of solid waste, wasted energy, and chemical use to clean corrugate for reuse. Furthermore, corrugated cardboard alone offers poor impact and vibration protection that must be compensated for through the addition of more corrugate, increasing packaging size and weight.

Accordingly, improved molded foam articles are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a molded foam article in accordance an embodiment of the present disclosure.

FIG. 2 is a protective package including two molded foam articles with ridges in accordance with an embodiment of the present disclosure.

### DETAILED DESCRIPTION

Containers such as thermal shippers and protective packaging are provided herein including molded foam articles formed from a single material, i.e., mono-material molded foam articles. In particular, it has been unexpectedly discovered that forming a container from two or more portions, each portion comprising a molded foam article consisting of polylactic acid-based molded bead foam, and joining the two or more portions together enables the formation of a container that consists entirely of a single material.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Protective Packaging

Protective packaging is provided herein that includes at least one molded foam article comprising polylactic acid (sometimes referred to herein as “expandable polylactic acid,” PLA, or EPLA), wherein the at least one molded foam article includes a plurality of ridges. As used herein, “molded foam article” refers to an article formed from a polymeric foam that has gone through an expansion and bead molding process. The article may be in the form of a two-dimensional panel or a three-dimensional structure such as a box.

These foam articles can be produced using conventional melt processing techniques, such as single and twin-screw extrusion processes. In one embodiment, foamed beads are produced by cutting extrudate at the face of the extrusion die. The foamed bead is subsequently optionally cooled by contacting with water, water vapor, air, carbon dioxide, or nitrogen gas. After the bead is cut at the face of the die, the bead continues to foam, thus forming a closed cell foam structure with a continuous surface skin, i.e. there is no open cell structure at the surface of the bead. In one embodiment, the resulting compostable or biobased, foamed bead has a density less than 0.15 g/cm³. In another embodiment, the compostable or biobased, foamed bead has a density of preferably less than 0.075 g/cm³, and most preferably less than 0.05 g/cm³.

As used herein, a “protective packaging” refers to any enclosure into which a consumer or commercial product may be placed for storage, shipping, and/or presentation to the user. For example, the container takes the form of protective packaging for fragile or breakable goods. In another example, the container may be a thermal shipper for shipping thermally sensitive goods.

As used herein, a “ridge” refers to a protrusion extending from the molded article. The ridges may be formed in various geometric shapes and configurations, including columns, triangular prisms, rectangular prisms, sinusoidal waves, honeycomb patterns, or any other suitable shape or arrangement. The ridges may be oriented vertically, horizontally, diagonally, or in any other direction with respect to the planar surface of the molded article. In some embodiments, the ridges may be arranged to form recognizable patterns, shapes, or designs, such as letters, numbers, logos, trademarks, or other symbols. For example, the ridges may be configured to create the shape of a specific alphanumeric character or a company logo when viewed from above. The cross-sectional profile of the ridges may also vary, including rectangular, triangular, semicircular, or any other suitable shape that allows for controlled compression and energy absorption when an external force is applied to the packaging. The ridges described herein are configured to reduce the amount of material used in the molded article. An EPS article, for example, may have a thickness of 2″, whereas a PLA-molded article having comparable or superior impact performance may have a primary thickness of 1″ and ridges that extend 1″ from the planar surface of the molded article. The use of ridges enables elimination of from about 10% to about 40% by volume of material while maintaining or improving impact protection and G-force reduction.

It has been unexpectedly discovered that by forming a protective packaging from one or more molded articles having ridges, the molded articles comprising polylactic acid, the impact protection and G-force reduction provided by the protective packaging meets or exceeds the protection provided by comparable expandable polystyrene (EPS) packaging. More specifically, the PLA-based molded article with ridges exhibits superior impact and G-force protection than either un-ridged PLA-based molded articles having the same primary thickness, EPS-based molded articles having the same primary thickness, or ridged EPS-based molded articles having identical dimensions. As used herein, the “primary thickness” refers to the thickness of the molded article without the ridges.

It has been further unexpectedly discovered that the protective packaging described herein is capable of superior impact protection and G-force reduction after repeated impacts. Conventional EPS protective packaging is designed to protect the contents from one drop, after which the packaging structural integrity is compromised either through fractures or unfavorable compression/densification of the foam article. For example, EPS-based molded articles have a low compressive set after molding. This low compressive set is exaggerated after additional compression such as by the impact of an article in an EPS-based packaging.

In some embodiments, the at least one molded foam article includes at least about 98% polylactic acid (PLA) by weight. As a result of such a high percentage of PLA in the article, the article is considered “biobased” and “compostable” in industrial facilities according to ASTM D6866 and ASTM D6400.

In some embodiments, the at least one molded foam article includes from greater than 0% to about 2% by weight of inorganic additives. In some embodiments, the inorganic additives include talc, chain extender, planar particles such as graphite, inert inorganic particles such as iron oxide, or a combination thereof. For example, the at least one molded foam article may include from about 0.6% to about 1.2% by weight of micronized mined graphite. For example, the at least one molded foam article may include from about 0.6% to about 1.2% by weight of iron oxide. For example, the at least one molded foam article may include from about 0.4% to about 1% by weight of micronized mined talc. For example, the at least one molded foam article may include from about 0.6% to about 1% by weight of a chain extender.

In some embodiments, the at least one molded article may include a chain extender to increase the molecular weight of the PLA during melt processing. This also has the effect of increasing melt viscosity and strength, which can improve the foamability of the PLA.

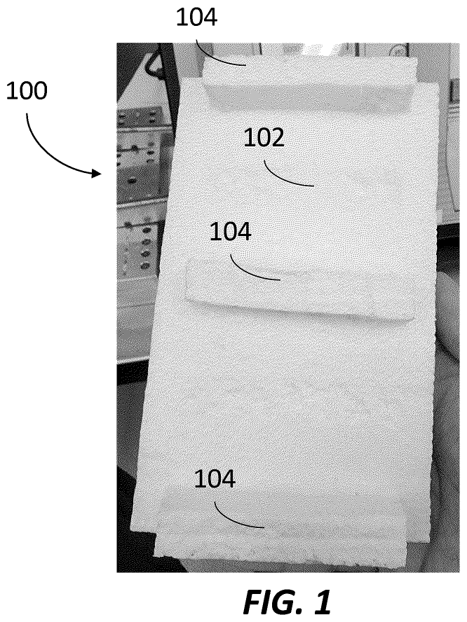

Turning now to the Figures, FIG. 1 depicts a molded article 100 formed from polylactic acid, the molded article 100 including a plank portion 102 and a plurality of ridges 104.

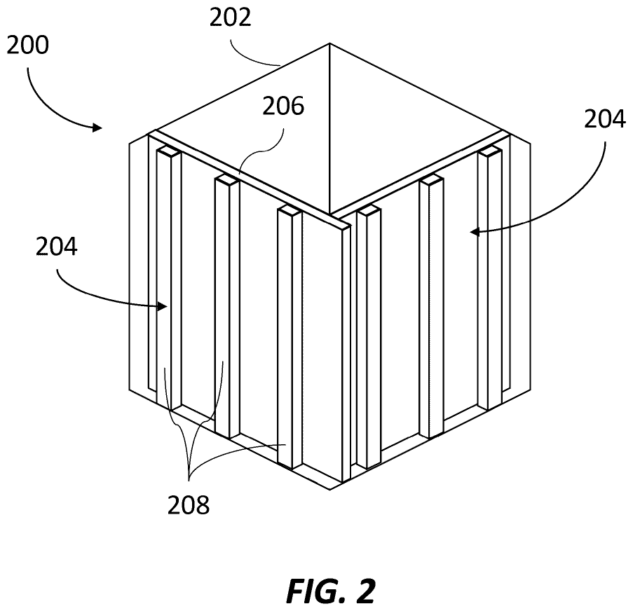

FIG. 2 depicts a protective package 200 including outer container 202 and molded foam articles 204. Each molded foam article 204 include a plank portion 206 and a plurality of ridges 208. Although the molded foam articles are depicted as having three ridges each, this is done in the interest of brevity only and it is to be understood that more or fewer ridges may be present. Furthermore, although the ridges are depicted as being perfectly vertical, the ridges may be horizontal, or there may be a combination of vertical and horizontal, or the ridges may form a hexagonal or “egg-crate” pattern. Any suitable ridge size, shape, quantity, and positioning may be utilized depending on the needs of the application.

### EXAMPLES

The disclosure may be further understood with reference to the following non-limiting examples.

### Example 1: Concentrated Impact Test

Five PLA-based formulations were used to form PLA-based foam articles each having a density of 1.5 PCF±0.1 PCF. Each formulation included from about 98% to about 98.8% by weight PLA, with the balance an inorganic additive. The inorganic additive in Formulation 1 is micronized mined graphite. The inorganic additive in Formulation 2 is iron oxide. The inorganic additive in Formulation 3 is micronized mined talc. The inorganic additives in Formulation 4 is both micronized mined graphite and iron oxide. The inorganic additives in Formulation 5 is both micronized mined graphite and micronized mined talc. The five PLA formulations are detailed in Table 1.

TABLE 1
PLA Formulations

| | | Micronized | Iron | Micronized |
|---|---|---|---|---|
| PLA | PLA | Mined | Oxide | Mined |
| Formulation | (wt %) | Graphite (wt %) | (wt %) | Talc (wt %) |
| Formulation 1 | 98-99.8% | 0.2-2% | — | — |
| Formulation 2 | 98-99.5% | — | 0.5-2% | — |
| Formulation 3 | 98-99% | — | — | 1-2% |
| Formulation 4 | 98-99.3% | 0.2-1% | 0.5-1% | — |
| Formulation 5 | 98-99.3% | 0.2-1.5% | — | 0.5-1.8% |

A chain extender may be added to any of these formulations depending on PLA type and drying characteristics. It is further expected that a formulation including about 98% by weight PLA, from about 0.4 to about 0.7% by weight micronized mined graphite, from about 0.8 to about 1.1% by weight iron oxide, and from about 0.5 to about 1.2% by weight micronized mined talc would exhibit even more favorable properties than Formulations 1-5, which are described in further detail below.

An EPS-based article having a density of 1.2 PCF was also prepared. Each sample was subjected to a concentrated impact test according to ASTM 6344-04. The test involved a guided freefall drop of a 1.5″ diameter cylindrical mass from a height of 40″ so that each sample experiences an impact force of 6.8 J. The effect of the impact on each sample was analyzed 24 hours after impact to account for recovery of the foam article. The results of the impact test are displayed in Table 2 for a single impact. Table 3 for three impacts, and Table 4 for ten impacts.

TABLE 2
Single Concentrated Impact

| | Impression | Crack | Impression: | Crack: |
|---|---|---|---|---|
| | Depth | Depth | Height | Height |
| Sample | (mm) | (mm) | Ratio | Ratio |
| EPS | 3 | 14 | 8% | 37% |
| PLA | 2 | 12 | 5% | 32% |
| Formulation 1 | | | | |
| PLA | 2.5 | 3 | 7% | 8% |
| Formulation 2 | | | | |
| PLA | 3.5 | 12.5 | 9% | 33% |
| Formulation 3 | | | | |
| PLA | 2.5 | 8 | 7% | 21% |
| Formulation 4 | | | | |
| PLA | 3.5 | 12 | 9% | 32% |
| Formulation 5 | | | | |

TABLE 3
Three Concentrated Impacts

| | Impression | Crack | Impression: | Crack: |
|---|---|---|---|---|
| | Depth | Depth | Height | Height |
| Sample | (mm) | (mm) | Ratio | Ratio |
| EPS | 7 | 25 | 18% | 66% |
| PLA | 5 | 23 | 13% | 61% |
| Formulation 1 | | | | |
| PLA | 4.5 | 5 | 12% | 13% |
| Formulation 2 | | | | |
| PLA | 4 | 24 | 11% | 63% |
| Formulation 3 | | | | |
| PLA | 6.5 | 17 | 17% | 45% |
| Formulation 4 | | | | |
| PLA | 4.5 | 12.5 | 12% | 33% |
| Formulation 5 | | | | |

TABLE 4
Ten Concentrated Impacts

| | Impression | Crack | Impression: | Crack: |
|---|---|---|---|---|
| | Depth | Depth | Height | Height |
| Sample | (mm) | (mm) | Ratio | Ratio |
| EPS | 7.2 | 27 | 19% | 71% |
| PLA | 6.5 | 25 | 17% | 66% |
| Formulation 1 | | | | |
| PLA | 5 | 15 | 13% | 39% |
| Formulation 2 | | | | |
| PLA | 8 | 24 | 21% | 63% |
| Formulation 3 | | | | |
| PLA | 7.5 | 22 | 20% | 58% |
| Formulation 4 | | | | |
| PLA | 6 | 16.6 | 16% | 44% |
| Formulation 5 | | | | |

Table 2 illustrates the surprisingly substantial effect various inorganic additives can have on the impact resistance of various foam articles. PLA Formulation 2 exhibited the lowest crack:height ratio, which would be an indication of hidden damage within the foam, while EPS exhibited the highest crack:height ratio. This disparity is further evident after three concentrated impacts; PLA Formulation 2 exhibited only a 13% crack:height ratio after three drops while the EPS sample exhibited a 66% crack:height ratio.

Although ten concentrated impacts are an unlikely use-case, the test results further demonstrated favorable impact properties for all PLA formulations over EPS.

### Example 2: Deformation Analysis

The 6 samples tested in the single impact test in Example 1 were analyzed to determine the depth of the impression made by the weighted cylinder. Both the initial impression depth and the impression depth after 24 hours were measured. The degree of “recovery” of the material, i.e., whether and by how much the impression depth lessens over time as the foam article returns to its original shape, can be an important predictor for determining how the foam article will behave if subjected to future impacts or vibrations. The results are displayed in Table 5.

TABLE 5
Single Impact Impression Depth Analysis

| | Initial Impression | 24 hr Impression | Recovery |
|---|---|---|---|
| Sample | Depth (mm) | Depth (mm) | % |
| EPS | 3.5 | 3.5 | 0% |
| PLA | 2.5 | 2 | 20% |
| Formulation 1 | | | |
| PLA | 3 | 3 | 0% |
| Formulation 2 | | | |
| PLA | 4 | 3.5 | 13% |
| Formulation 3 | | | |
| PLA | 4 | 3 | 25% |
| Formulation 4 | | | |
| PLA | 4.5 | 3 | 33% |
| Formulation 5 | | | |

Table 5 demonstrates that EPS-based foam articles experience little-to-no recovery after a single impact. In practice, protective packaging that relies on EPS would therefore provide some degree of impact protection and G-force reduction for a single impact; subsequent impacts may damage the contents because the EPS foam does not recover from the initial impact. Table 5 also shows that Formulation 2, which exhibited the most favorable crack:height ratio in Example 1, has poor recovery properties. Formulation 5 appears to possess both favorable crack:height ratio and favorable recovery properties.

### Example 3: Impression Depth Analysis with 10 Pound Weight

A similar drop test as the one performed in Example 1 was performed with a 10 pound weight having an 8″ diameter, dropped via directed free fall from a height of 20″ such that the sample is subjected to 14.2 J of energy. EPS and the same five PLA formulations as those described in Table 1 were analyzed. The results are displayed in Table 6.

TABLE 6
Single Impact Impression Depth with 10 Pound Weight

| Sample | Impression Depth (mm) |
|---|---|
| EPS | 5 |
| PLA Formulation 1 | 3.5 |
| PLA Formulation 2 | 3 |
| PLA Formulation 3 | 2.5 |
| PLA Formulation 4 | 4.5 |
| PLA Formulation 5 | 3.5 |

Table 6 further demonstrates the reduced impression depth of PLA-based foam articles as compared to EPS.

### Example 4: Angled Impact Tests

EPS and PLA formulations according to those described in Example 1 were prepared and subjected to angled impact tests according to ASTM 5265-23. This test involves a 12″ cube-shaped box with 9 pounds of weight undergoing a guided free fall from a height of 22″ onto a foam piece so that 14 J of impact is experienced. The test simulates another package falling onto the protective packaging at an angle. The impression depth is displayed in Table 7.

TABLE 7
Angle Impact Test Results

| Sample | Impression Depth (mm) |
|---|---|
| EPS | 3 |
| PLA Formulation 1 | 0.7 |
| PLA Formulation 2 | 2.3 |
| PLA Formulation 3 | 2.5 |
| PLA Formulation 4 | 1.5 |
| PLA Formulation 5 | 0.7 |

As demonstrated in Example 3, the PLA formulations in Table 7 exhibited a lower impression depth than the EPS, further indicating the favorable impact properties of PLA based protective packaging over EPS.

### Example 5: G-force Reduction Analysis

A study was performed to determine the peak rebound acceleration of payloads within protective packaging. Four protective packages were prepared: EPS-based panels, EPS-based panels with ridges, PLA-based panels, and PLA-based panels with ridges. The PLA-based panels were formed using Formulation 5 from Example 1. Each package was loaded with a 3.5 pound payload having dimensions of 7″×5″×3″, which results in a static stress on the foam panels abutting the payload of 0.1 psi (non-ridged panels) or 0.2 psi (ridged panels). Each package was dropped 7 times from a height of 40″ and the acceleration of the payload was measured with an accelerometer. The lowest and highest acceleration peaks experienced by the payload across the 7 drops, along with the average of all seven acceleration peaks, is displayed in Table 8.

TABLE 8
Rebound Acceleration Peaks (G-Force)

| Sample | Low (G) | High (G) | Average (G) |
|---|---|---|---|
| EPS Panel | 2.1 | 8 | 3.4 |
| EPS Ridged | 3.9 | 16 | 8.9 |
| PLA Formulation 5 | 4 | 15 | 7.7 |
| PLA Formulation 5, Ridged | 0.7 | 3.8 | 2.0 |

Note that the G-Force is measured in units G, where 1 G corresponds to the unmodified force due to gravity experienced by the payload, i.e., the payload's weight. At 2 G, the payload experiences force equal to having twice its weight, for example.

As shown in Table 8, the ridged PLA has dramatically improved performance over EPS with an average G-force over 40% lower than EPS and over 77% lower than EPS with ridges. A maximum G-force of 3.8 is a significant improvement for a protective package having such a low weight.

### Example 6: Egg Drop Tests

A 0.75″ thick plank of EPS and a 0.75″ thick plank of PLA Formulation 5 were prepared. A raw egg was enclosed in a plastic bag and dropped from a height of 12 feet using a pipe to direct the free fall of the egg onto each plank. For both EPS and PLA, the egg did not crack after the first drop. However, dropping a “fresh” egg onto each panel in the same spot as the first egg resulted in breaking the egg for the EPS panel, but no breakage for the PLA panel. This highlights the various differences demonstrated in Examples 1 and 2 such as the introduction of cracks after impact and the ability for the foam to recover after impact.

1. A protective package comprising at least one molded foam article comprising polylactic acid,
wherein the at least one molded foam article comprises a plurality of ridges.

2. The protective packaging of claim 1, wherein the at least one molded foam article comprises at least 98% polylactic acid by weight.

3. The protective packaging of claim 1, wherein the at least one molded foam article comprises 2% or less by weight of inorganic additives.

4. The protective packaging of claim 3, wherein the inorganic additives comprise talc, planar particles, inert inorganic particles, or a combination thereof.

5. The protective packaging of claim 1, wherein the at least one molded article comprises between about 0.2 to about 2% by weight of micronized mined graphite.

6. The protective packaging of claim 1, wherein the at least one molded article comprises between about 0.5 to about 2% by weight of iron oxide.

7. The protective packaging of claim 1, wherein the at least one molded article comprises between about 0.5 to about 2% by weight of micronized mined talc.

8. The protective packaging of claim 1, wherein the at least one molded article comprises between about 0.2 to about 1% by weight of micronized mined talc and from about 0.5 to about 1% by weight iron oxide.

9. The protective packaging of claim 1, wherein the at least one molded article comprises between about 0.2 to about 1.5% by weight of micronized mined graphite and from about 0.5 to about 1.8% by weight of micronized mined talc.

10. The protective packaging of claim 1, wherein the at least one molded article comprises about 98% by weight polylactic acid, about 1% by weight micronized mined graphite, and about 0.4% by weight micronized mined talc.

11. The protective packaging of claim 1, wherein the at least one molded article comprises about 98% by weight polylactic acid, from about 0.4 to about 0.7% by weight micronized mined graphite, from about 0.8 to about 1.1% by weight iron oxide, and from about 0.5 to about 1.2% by weight micronized mined talc.
